(19) United States
(12) Patent Application Publication
(10) Pub. No.: US 2016/0306827 A1
(43) Pub. Date: Oct. 20, 2016

(54) SYNCHRONIZING DATA RULES AND CORRESPONDING METADATA TO IMPLEMENT DATA GOVERNANCE

(71) Applicant: International Business Machines Corporation, Armonk, NY (US)

(72) Inventors: Cassio S. Dos Santos, Boston, MA (US); Kunjavihari M. Kashalikar, Hudson, MA (US)

(21) Appl. No.: 14/687,171

(22) Filed: Apr. 15, 2015

(51) Int. Cl. G06F 17/30

(52) U.S. Cl. CPC G06F 17/30289; G06F 17/30368

(57) ABSTRACT

According to one embodiment of the present invention, a system monitors metadata to control rule execution and comprises at least one processor. The system detects changes to metadata within one or more repositories, and identifies one or more data processing rules associated with the metadata having the detected changes. An impact of the changed metadata on the identified one or more data processing rules is identified, and execution of the one or more data processing rules is controlled based on the determined impact of the changed metadata. Embodiments of the present invention further include a method and computer program product for monitoring metadata to control rule execution in substantially the same manner described above.

### BACKGROUND

1. Technical Field

Present invention embodiments relate to data governance, and more specifically, to updating data quality and other rules in accordance with monitored changes to metadata to maintain synchronization between the rules and metadata for accurate data governance.

2. Discussion of the Related Art

Enterprise-wide data governance initiatives involve the collection and storage of metadata from a potentially large and disparate set of data sources into a centralized metadata repository. The metadata is required in order to enable a number of governance related processes (on the metadata stored in those data sources) including profiling, classification, validation, standardization, and obfuscation. Data governance processes typically involve the definition of different types of rules and jobs that assume the metadata corresponding to those rules and jobs is current.

In a typical scenario, profiling is performed (including domain analysis and sensitive data discovery) on data from multiple data sources and, based on the profiling results, a variety of data rules (validation rules, matching rules, standardization rules, masking rules) are created and/or applied to validate, cleanse, standardize, and obfuscate the data. When data rules are run periodically or new data needs to be profiled, the metadata upon which the profiling and data rule definitions are (directly or indirectly) based may have changed in a way that renders the profiling and/or data rule results invalid. When metadata becomes stale, the execution of such processes may still succeed but produce invalid or incomplete results, which could undermine the effectiveness of the governance initiatives.

For example, data validation is a valuable currency an enterprise possesses. Evaluation of data validation rules (at the data source, during movement (Extract, Transform, Load (ETL)/Extract, Load, Transform (ELT)), or at a destination) for correctness of values and formats is a key in ensuring quality of data. Enterprises spend a considerable amount of resources to create and execute data validation rules, and to take corrective actions for exceptions found by the validation process.

Data validation rules are based on metadata collected from data sources. Over time, the metadata and corresponding data validation rules lack synchronization, thereby resulting in obsolete data validation rules. Obsolete data validation rules can lead to creation of invalid exceptions or missed data violations (violations that are flagged in a data validation rule execution prior to the metadata change). Invalid exceptions waste resources employed for analysis and remediation of the wrongly reported exceptions. Missed exceptions provide incorrect assumptions about the quality of the data that is used to drive business decisions and may be harder to detect.

Conventional approaches typically involve a combination of periodic synchronization (re-importation) and analysis of metadata to assess the impact of changes to existing data validation rules in a governance process. However, the changes are detected only when, and if, metadata is re-imported, and the volume of metadata that needs to be regularly re-imported and analyzed may be very large, thereby being impractical for performing frequent analysis. Further, impact analysis may require subject matter expertise and human intervention to identify the need for corrective actions, while long detection-remediation cycles may lead to wrong results (false positives) being utilized to drive decisions before corrective actions can be applied.

### SUMMARY

According to one embodiment of the present invention, a system monitors metadata to control rule execution and comprises at least one processor. The system detects changes to metadata within one or more repositories, and identifies one or more data processing rules associated with the metadata having the detected changes. An impact of the changed metadata on the identified one or more data processing rules is identified, and execution of the one or more data processing rules is controlled based on the determined impact of the changed metadata. Embodiments of the present invention further include a method and computer program product for monitoring metadata to control rule execution in substantially the same manner described above.

### BRIEF DESCRIPTION OF THE DRAWINGS

Generally, like reference numerals in the various figures are utilized to designate like components.

FIG. 1 is a diagrammatic illustration of an example computing environment of an embodiment of the present invention.

FIG. 2 is a diagrammatic illustration of a server system of FIG. 1 according to an embodiment of the present invention.

FIG. 3 is a flow diagram of a manner of synchronizing data rules with metadata changes according to an embodiment of the present invention.

FIG. 4 is a procedural flowchart illustrating a manner of synchronizing data rules with metadata changes in response to refreshing metadata according to an embodiment of the present invention.

FIG. 5 is a diagrammatic illustration of an example table added to a schema that alters metadata.

FIG. 6 is a manner of detecting the change to metadata illustrated in FIG. 5 and synchronizing data rules with the metadata change according to an embodiment of the present invention.

FIG. 7 is a diagrammatic illustration of the example table of FIG. 5 after currency evaluation of metadata according to an embodiment of the present invention.

FIG. 8 is a procedural flowchart illustrating a manner of synchronizing data rules with metadata changes in response to data rule execution according to an embodiment of the present invention.

FIG. 9 is a diagrammatic illustration of an example table modification that alters metadata.

FIG. 10 is a manner of detecting the change to metadata illustrated in FIG. 9 and synchronizing data rules with the metadata change according to an embodiment of the present invention.

FIG. 11 is a diagrammatic illustration of the example table of FIG. 9 after synchronization of the data rules with the metadata change according to an embodiment of the present invention.

### DETAILED DESCRIPTION

Embodiments of the present invention provide automatic implementation of data governance rules and/or periodic validation of data rule currency to detect changes to metadata upon which the data governance rules depend. The results of these activities may initiate re-validation and updating of the data rule implementations.

For example, an enterprise may receive customer information in flat files, and load the customer information into a relational database system. Based on information from a supplier of the customer information, a zip code is defined for a column as a five digit field. A validation rule that checks the zip code ensures the field contains five numbers. As part of a batch load process, the zip code field is populated along with other fields. The validation rule is executed as part of the batch load process to identify records that do not satisfy the validation rule.

The customer information provider may later update the flat files to provide a zip code in a nine digit format. The field containing the zip code is modified to reflect a four digit zip code extension. An attempt is made to load this new data; however, the validation rule identifies a number of exceptions.

Since the data structure from the flat file and the field match, and the data record that is indicated in the exception clearly contains nine digits, the reason for the exception is difficult to ascertain. The cause of the exception is that the validation rule lacks synchronization with new metadata, as well as the new data to load. Thus, the data that was in fact correct, was incorrectly identified as being in error due to stale metadata.

In another example, an enterprise stores a customer identification number that is all numerical in a column of a database table. A data rule is created to check that the column contains only numerical values. All the data entering the system is validated using this data rule.

The enterprise instituted a change, and utilizes a social security number (SSN) as the customer identification. To reflect this change, the database table column is updated to a text field in a “999-99-9999” format. The data structures are updated to support this change. When the next set of data is processed, a large number of exceptions are reported. After lengthy investigations, the data rule is identified as being stale, and all the exceptions are marked as invalid. However, a number of records processed had an incorrect conversion (e.g., the letter ‘O’ instead of a zero), and these errors remain in the system.

An embodiment of the present invention may use a metadata repository to create links between data sources, data characterization details, data governance rules, and data stewards or other users, and evaluate metadata changes as the changes become known. As a result, metadata changes can be detected as the changes occur, and evaluated for impact before actually impacting governance assets and users (e.g., detection of now obsolete data rules).

A collection of data sources are scanned to detect metadata changes (without actually importing the changes into a central metadata repository, thereby shielding downstream uses from impact of those changes). This collection could be user defined to enable selection of high value/high impact data sources. A user may view governance rules to self check currency, and request a scan of metadata changes for the corresponding data of the governance rule. The metadata changes are detected in a data source under inspection. Using the central metadata repository, rules and characterizations are determined and applied to the data source, where the metadata from the data source is marked to indicate obsolescence or further inspection required.

A notification may be generated to indicate the metadata changes. Users are provided details to improve effectiveness of their action. In addition, systems that receive notification may act without user intervention, thereby improving response time. Execution of governance rules deemed obsolete due to changes in metadata is prevented to protect against incorrect results.

A present invention embodiment may accommodate each of the above examples. In particular, the zip code from the above example may be deemed a high value asset, where corresponding metadata is checked every night. When the zip code field is changed to add the additional four digits, the metadata change is detected (using the knowledge in the central metadata repository for the validation rule applied to this data source), and a user may be notified to review. The validation rule may be updated by a user or the system to reflect the metadata change. A batch process may be flagged to indicate that the validation rule should be updated prior to the batch process being run. The validation rule is updated ahead of the batch process, thereby avoiding the exceptions.

With respect to the above customer identification example, the data rule checks for currency of the database table in a present invention embodiment. Based on the detection of the metadata change, this data rule is marked as obsolete. A notification of the change in the column data type (e.g., from numeric to text) may be provided including a metadata change report. A new rule is identified which checks that the information in the column adheres to the updated (SSN) format. The new identified rule is now run, and detects the entries providing exceptions. Thus, with data rule currency verified by a present invention embodiment, the erroneous data may be located and remediated.

A present invention embodiment provides data governance policies and rules enabling detection and automatic inference of the potential impact of those changes to implemented governance policies. A present invention embodiment effectively monitors metadata currency in the context of metadata driven governance activities, and updates impacted rules according to currency related policies. A change in the metadata may reflect various changes to the structure of existing data sets including: a newly added column/table, a modified column type/length, and a new/modified integrity constraint. A framework is provided to detect metadata changes and the impact of those changes when; metadata is explicitly refreshed (or re-imported); currency rules generated to infer metadata currency are executed (e.g., manually or on a schedule); and existing governance rules are executed and the corresponding metadata is determined to be obsolete.

Since currency of metadata can impact the outcome of metadata-driven data governance activities in a number of ways, present invention embodiments may provide one or more various features. For example, a present invention embodiment may enable early data rule violation detection due to metadata changes (e.g., as the violations occur rather than after the occurrence), and may provide detection of metadata changes and automatic inference of the potential impact of the metadata changes to implemented data governance policies and rules. Further, a metadata change may be automatically determined to invalidate a data rule applied to a data store. This enables more governance and intelligence by determining the impact of metadata change, and not just the data change itself. Thus, an insight/understanding is provided on the impact of a change of metadata on data quality evaluation of data persisted in systems that the metadata describes.

Moreover, a present invention embodiment may provide the ability to create rules to determine when an evaluation is created/needed and to react ahead of absorbing data schema changes, and may allow pluggable metadata change detection algorithms. In addition, a present invention embodiment continuously monitors validation of data governance rules for high value assets to guard against obsolescence, and performs obsolescence/invalidation of quality/governance measurements.

In particular, a present invention embodiment ensures currency of data rules (e.g., validation, classification, standardization, etc.) and prevents generation of invalid results. When a data rule is first created and bound to a given data source for execution, a snapshot of metadata of the data source is persisted. Columns/tables validated by the data rule and used for creating exception records are identified and annotated. Data rule currency may be verified at rule run time. Prior to execution of a data rule against a data source, metadata of the data source is retrieved and compared against a persisted data source. If no changes to the metadata are detected for the tables and identified columns of interest, the rule is executed. If changes to the metadata are detected, the rule execution is suspended and a notification is sent to signal obsolescence and trigger the appropriate actions.

A policy driven execution of the same comparison is supported to allow for rule currency validation ahead of a scheduled data rule execution. In this case, currency validation is performed at a given interval or in a predetermined time span ahead of a data rule execution. All data rules with metadata found to be obsolete are flagged and removed from an execution schedule.

Moreover, customization of the detection process may be performed to further refine evaluation of metadata changes that may make a data rule obsolete. A simple extensible syntax is provided to define the metadata change that designates a data rule obsolete. Accordingly, the metadata changes that impact actual implementation of the data rule or the generation of exception details designates a data rule obsolete.

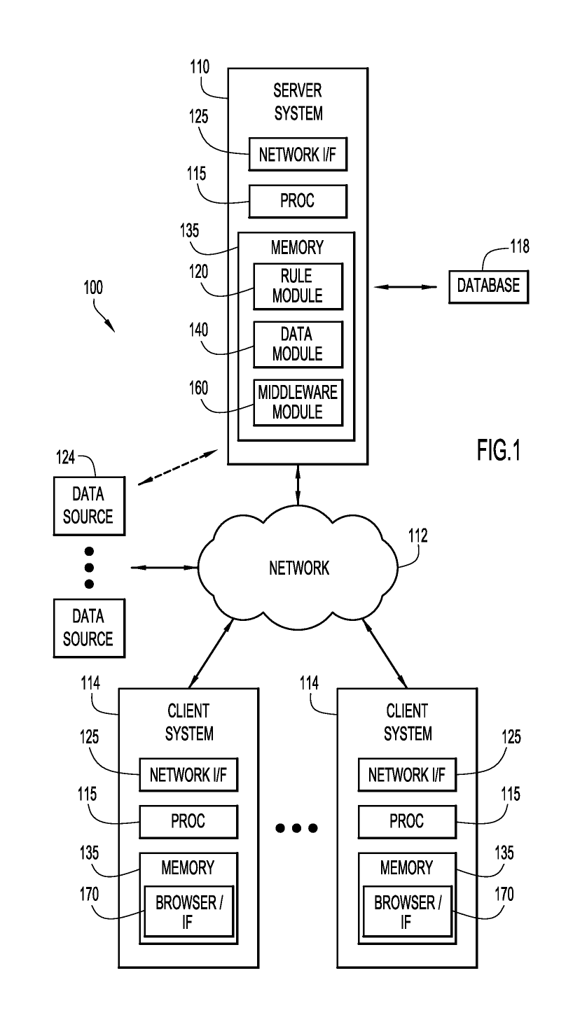

An example computing environment for use with present invention embodiments is illustrated in FIG. 1. Specifically, the computing environment includes one or more server systems 110, one or more client or end-user systems 114, and one or more data sources 124. Server systems 110, client systems 114, and data sources 124 may be remote from each other and communicate over a network 112. The network may be implemented by any number of any suitable communications media (e.g., wide area network (WAN), local area network (LAN), Internet, Intranet, etc.). Alternatively, server systems 110, client systems 114, and data sources 124 may be local to each other, and communicate via any appropriate local communication medium (e.g., local area network (LAN), hardwire, wireless link, Intranet, etc.).

Client systems 114 include a browser/interface or other client module 170 to enable users to interact with server systems 110 to provide and receive information pertaining to data quality evaluation and migration. The client systems may present a graphical user (e.g., GUI, etc.) or other interface (e.g., command line prompts, menu screens, etc.) to solicit information from users, and may provide reports or other information.

The server systems include a rule module 120 to control rule execution, a data module 140 to import, refresh, and track data and metadata, and a middleware module 160 to interface various data sources 124. One or more database systems 118 may store various information (e.g., data, metadata, serve as a staging repository for metadata, serve as a central metadata repository, etc.). The database systems and data sources 124 may be implemented by any conventional or other database or storage unit, may be local to or remote from server systems 110 and client systems 114, and may communicate via any appropriate communication medium (e.g., local area network (LAN), wide area network (WAN), Internet, hardwire, wireless link, Intranet, etc.). Data sources 124 may be of any quantity, and may include the same or any quantity of different types of data sources (e.g., IBM DB2 data source, Java Database Connectivity (JDBC) data source, etc.).

Server systems 110 and client systems 114 may be implemented by any conventional or other computer systems preferably equipped with a display or monitor, a base (e.g., including at least one processor 115, one or more memories 135 and/or internal or external network interfaces or communications devices 125 (e.g., modem, network cards, etc.)), optional input devices (e.g., a keyboard, mouse or other input device), and any commercially available and custom software (e.g., server/communications software, rule module, data module, middleware module, browser/interface or client module 170, operating system, etc.).

Rule module 120, data module 140, middleware module 160, and client module 170 may include one or more modules or units to perform the various functions of present invention embodiments described below. The various modules (e.g., rule module 120, data module 140, middleware module 160, client module 170, etc.) may be implemented by any combination of any quantity of software and/or hardware modules or units, and may reside within memory 135 of the corresponding server and client systems for execution by processor 115.

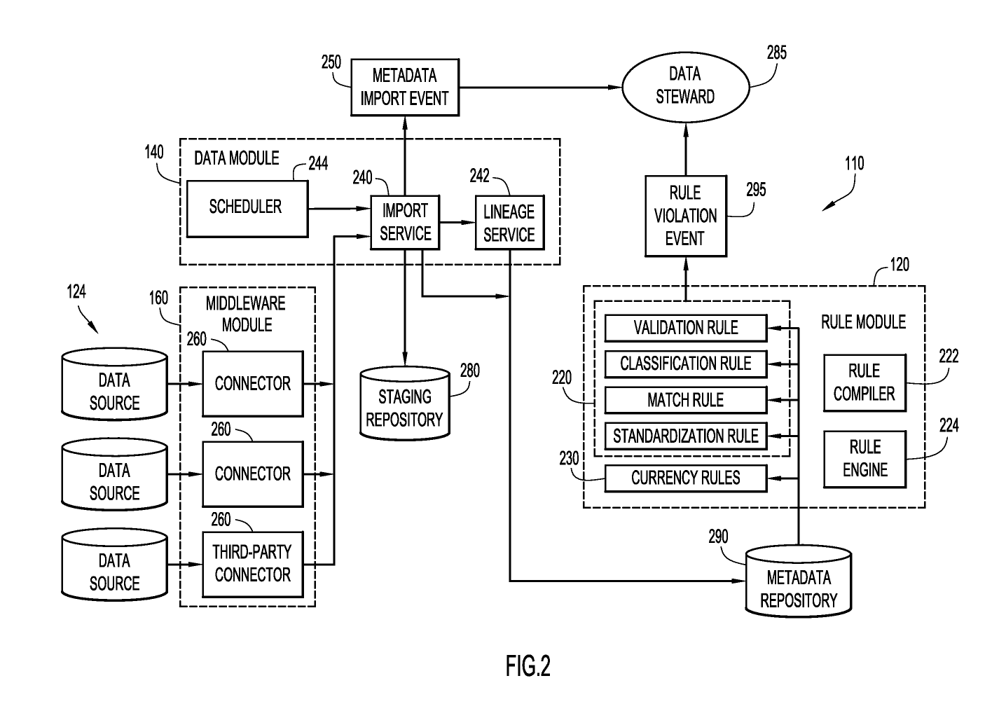

Referring to FIG. 2, server system 110 includes rule module 120, data module 140, and middleware module 160. Middleware module 160 couples data sources 124 to data module 140 for importing and refreshing (or re-importing) data and metadata. The middleware module provides a centralized metadata acquisition framework allowing a number of data source connectors to be used, and new data source connectors to be implemented and plugged in to enable the selection and retrieval of data and metadata from a variety of data sources. Specifically, middleware module 160 includes one or more connectors 260 each to retrieve data and metadata from a corresponding data source 124. The connectors may each provide a specific interface for a corresponding one of the different types of data sources 124 employed by the environment (e.g., a connector 260 for an IBM DB2 data source, a connector 260 for a Java Database Connectivity (JDBC) data source, a third party connector for a data source, etc.).

Connectors 260 may provide detection of changes within the metadata being refreshed from data sources 124. In this case, the connectors provide the specific interfaces to the data sources, thereby having access to catalogs of the data sources and the capacity to interpret the metadata for comparisons. The connectors each compare the incoming metadata to the catalog of the corresponding data source (e.g., including timestamps, etc.) for prior metadata to determine changes occurring within the incoming metadata. The changes to the incoming metadata are reported to data module 140 for tracking and metadata currency determinations as described below.

Data module 140 includes an import service 240, a lineage service 242, and a scheduler 244. The import service controls the importing and refreshing (or re-importing) of data and metadata from data sources 124. The import service provides a notification 250 to one or more subscribing data stewards or other users 285 in response to an error or exception during retrieval of the metadata. This notification is via a subscription/notification framework implemented by the data and rule modules that allows users to subscribe to events (e.g. data and/or currency rule violations, metadata retrieval, etc.) and be notified of the occurrence of those events.

Import service 240 may further store the incoming metadata in a staging repository 280 (e.g., implemented by a database 118) prior to storage for sharing in a central metadata repository 290 (e.g., implemented by a database 118). The central metadata repository stores metadata about the data sources (e.g. data source connections, databases, database schemas, tables, columns, keys, data files, data fields, etc.), jobs, data and currency rules, and data transformations, and is used in the definition and implementation of data policies and data rules governing those data sources. This information typically resides within the metadata retrieved from data sources 124. The central metadata repository further stores associations of governance rules (e.g., data rules, etc.) and data characterization (e.g., Personally identifiable Information (PII) classification, etc.) to these data sources.

Further, the import service may alternatively determine changes to the incoming metadata (in addition to or instead of connectors 260), and provide a metadata retrieval workflow that maintains a history of retrieved metadata allowing detection of changes relative to prior metadata based on differences between retrieval events (e.g., metadata added/modified/deleted). In this case, the incoming metadata may be stored within staging repository 280 for verification prior to storage for sharing in central metadata repository 290. This provides an opportunity to verify the incoming metadata prior to enabling that metadata to be shared, and assists with preventing downstream issues from arising. For example, the import service may produce a history of metadata in staging repository 280, and report which objects and processes (e.g., schemas, tables, columns, etc.) were added, modified, and/or deleted since the last retrieval event. The incoming metadata within staging repository 280 may be compared to the metadata in central metadata repository 290 to determine the changes and types of changes to the incoming metadata based on the comparison. This information may be added to the history. The import service may determine an appropriate action (e.g., merge, overwrite, and/or add to metadata in the central metadata repository, not provide the incoming metadata to the central metadata repository, further analysis of the changes, etc.) based on the determined changes. By way of example, when the incoming metadata includes additive changes (e.g., additional elements are added), these types of changes should not affect current operations and, therefore, the incoming metadata can be provided to central metadata repository 290. However, destructive changes (e.g., removal of elements) are likely to affect operations, and may be reviewed in the staging repository prior to storage of the incoming metadata in the central metadata repository.

In addition, the import service may perform an impact and/or usage analysis of the incoming metadata (e.g., database schema, tables and columns, data file descriptors, etc.) based on the incoming metadata and/or history of prior metadata within staging repository 280. For example, the incoming metadata and/or histories may be analyzed to identify initial objects related to the changed metadata. This analysis reduces the set of objects for data lineage analysis (by lineage service 242 described below) that identifies related or dependent objects (and corresponding data rules) potentially impacted by the metadata changes. Alternatively, the incoming metadata may be directly stored in the central metadata repository (e.g., obviating the staging repository, verification, and/or impact analysis).

The importation or refresh of metadata may occur periodically or at certain times in order to maintain the metadata in a current state. The metadata and data may be imported and/or refreshed together, or individually at the same or different times. Scheduler 244 schedules tasks for server system 110 including a task for the importation or refresh of the metadata from data sources 124. The scheduler may be a component of an operating system of server system 110.

Lineage service 242 tracks data movement and transformations, and provides a data lineage framework that infers which downstream data objects and processes are potentially impacted by changes to upstream data objects and processes. For example, the lineage service maintains information pertaining to a source of data, a destination for the data, and transformations performed on the data. The lineage service may further query the central metadata repository to determine metadata pertaining to data sources 124, data rules, and jobs. The lineage service receives the change information for incoming metadata from import service 240, and may query the central metadata repository to determine the objects, data rules, and/or processes related to the changes for further analysis.

Rule module 120 controls application of data and currency rules, and includes data (or data processing) rules 220 (e.g., validation rules, classification rules, match rules, standardization rules, etc.), a rule compiler 222, and a rule engine 224. Data rules 220 include various rules each specifying criteria in the form of conditions and/or variables (e.g., with values retrieved from data sources 124 and/or central metadata repository 290) to verify data for a particular property (e.g., validity of the data, classification of the data, matching data with other data, data being in a standardized form, etc). The data rules generally vary depending on the data and a particular application, and are preferably bound to be applied to specified data objects, data elements, and/or processes.

Data rules 220 are compiled by rule compiler 222, where the resulting compiled data rule is executed by rule engine 224. The compiled data rule is typically in a form of executable code that is executed by the rule engine to apply the data rule to corresponding data. The rule module provides a notification 295 to one or more subscribing data stewards or other users 285 in response to a violation of a data rule. This notification is via the subscription/notification framework that allows users to subscribe to events (e.g., data and/or currency rule violations, metadata retrieval, etc.) and be notified of the occurrence of those events as described above.

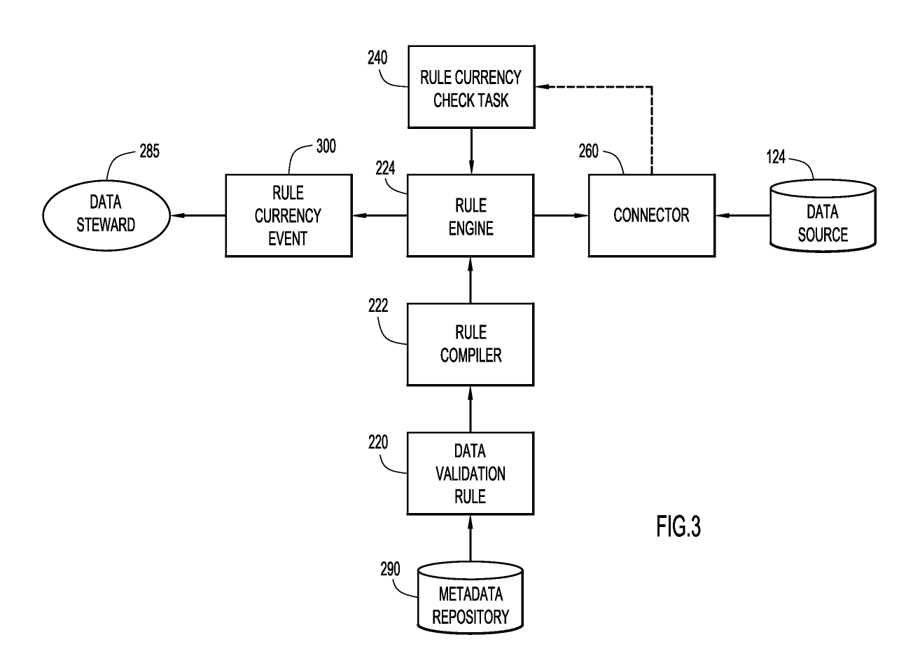

In addition, rule module 120 includes currency (or metadata) rules 230 that specify criteria in the form of conditions and/or variables (e.g., with values retrieved from data sources 124 and/or central metadata repository 290) to verify currency of metadata for a corresponding data rule 220 verify that the metadata is synchronized with the corresponding data rule). The currency rules generally vary depending on the data, data rule, metadata, and a particular application. Currency rules 230 are compiled by rule compiler 222, where the resulting compiled currency rule is executed by rule engine 224 to verify synchronization between data rules and corresponding metadata (e.g., at refresh of the metadata, scheduled or periodic intervals, or initiation of the synchronization verification by a user). The compiled currency rule is typically in a form of executable code that is executed by the rule engine to apply the currency rule to corresponding metadata. In response to a violation of a currency rule, the rule module may provide a notification 300 (FIG. 3) to one or more subscribing data stewards or other users 285. This notification is via the subscription/notification framework that allows users to subscribe to events (e.g., data and/or currency rule violations, metadata retrieval, etc.) and be notified of the occurrence of those events as described above. The corresponding data rules may be updated by the system or a user based on the currency rule violation.

The rule compiler may further generate and compile a currency rule 230 during compilation of a corresponding data rule in order to execute the currency rule during execution of the data rule. The compiled currency rule is typically in a form of executable code that is executed by the rule engine to apply the currency rule to corresponding metadata. In this case, the compiled data rule is extended by the rule compiler to execute the corresponding currency rule during execution of the data rule. In response to a violation of a currency rule, the rule module may provide a notification 300 (FIG. 3) to one or more subscribing data stewards or other users 285, and suspends execution of the corresponding data rule. This notification is via the subscription/notification framework that allows users to subscribe to events (e.g., data and/or currency rule violations, metadata retrieval, etc.) and be notified of the occurrence of those events as described above. The corresponding data rule may be updated by the system or a user based on the currency rule violation.

The synchronization between data rules and the corresponding metadata for those data rules may be determined at various instances including importation or refreshing of metadata from data sources 124, execution of data rules 220, and at periodic intervals or specified times (e.g., scheduled intervals or times specified by a user, synchronization manually initiated by a user or a user command, etc.).

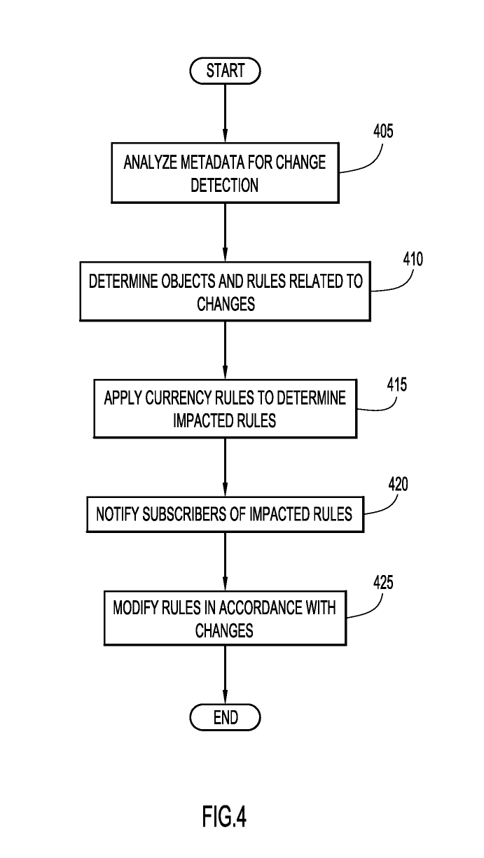

A manner of determining synchronization between data rules and corresponding metadata for those data rules according to an embodiment of the present invention is illustrated in FIGS. 3 and 4. Initially, detection of metadata currency may be performed when an attempt to refresh (or re-import) metadata is performed, either manually or automatically/periodically (e.g., as a scheduled background or other task). In this case, connectors 260 retrieve the metadata from data sources 124 as described above. The incoming metadata is analyzed for change detection at step 405. This may be accomplished by import service 240 based on the history of prior metadata stored in staging repository 280, and/or connectors 260 providing change information to the import service as described above.

An analysis of the changed metadata (e.g., database schema, tables and columns, data file descriptors, etc.) is performed by lineage service 242 to identify downstream objects (and corresponding data rules 220) potentially impacted by the metadata changes at step 410. The import service may further perform an impact/usage analysis of the incoming metadata as described above to identify initial affected objects and reduce the sets of objects analyzed by the lineage service.

Once data rules 220 impacted by the metadata changes have been identified, currency rules 230 associated with the identified data rules 220 (corresponding to the impacted objects) are applied by rule engine 224. The currency rules utilize the objects and/or changed metadata to identify data rules 220 lacking synchronization with corresponding changed metadata at step 415. For example, a violation of a currency rule indicates that the corresponding data rule may provide erroneous results. The rule engine processes the compiled currency rules in order to execute those currency rules (e.g., prior to the execution process (or run time) for the corresponding data rules).

Import service 240 may provide notifications 300 of the identified data rules (and currency rule violations) to a data steward or other user 285 at step 420, and the identified data rules may be modified based on the metadata changes at step 425. The data rule modifications may be implemented automatically by rule module 120. For example, a currency rule violation may indicate a modified data type for a table column (e.g., a text to numeric modification, etc.). In this case, rule module 120 may modify the data rule, or select a new data rule, with the updated data type indicated in the changed metadata (e.g., modify the text to be numeric within the data rule, etc.). Alternatively, the data steward or other user may modify the data rule or select a new data rule according to notification 300. The modified or selected rule may be compiled by rule compiler 222 for execution.

Since metadata can be refreshed on a schedule (e.g., daily, etc.), the currency of the governance assets (e.g., data validation or other rules) relative to the corresponding metadata from the data sources may be automatically monitored and any required adjustments made on a regular basis.

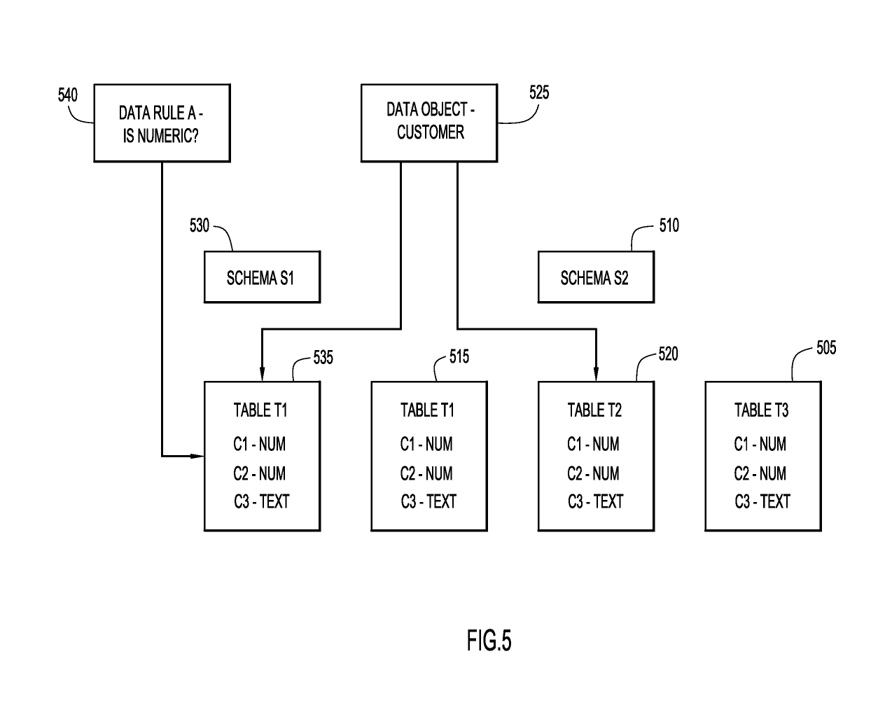

Operation of a present invention embodiment with respect to an example table addition is illustrated in FIGS. 5-7. By way of example, a new table 505 (e.g., Table T3) (FIG. 5) is added to a schema 510 (e.g., Schema S2) including tables 515 (e.g., Table T1) and 520 (e.g., Table T2). New table 505 (Table T3) is added as part of a definition of a data object 525 (e.g., Customer). The definition of the data object further applies to table 520 (Table T2). The example further includes a schema 530 (Schema S1) including table 535 (Table T1 of Schema S1), and a data rule 540 (e.g., Data Rule A, verifying that a column contains only numeric characters (e.g., IsNumeric) and is bound to columns C1 and C2 in table 535). Table 535 (Table T1 of Schema S1) is part of the definition of data object 525 (e.g., Customer).

Absent a mechanism for tracking metadata changes and the impact on data characterization, this change may not be noticed, thereby maintaining an inaccurate definition of data object 525 (e.g., Customer) and resulting in inferior decision making. If new table 505 (e.g., Table T3) represented a customer account balance, the business assessment of high value customers will be incorrectly impacting business decisions and services offered to the customer.

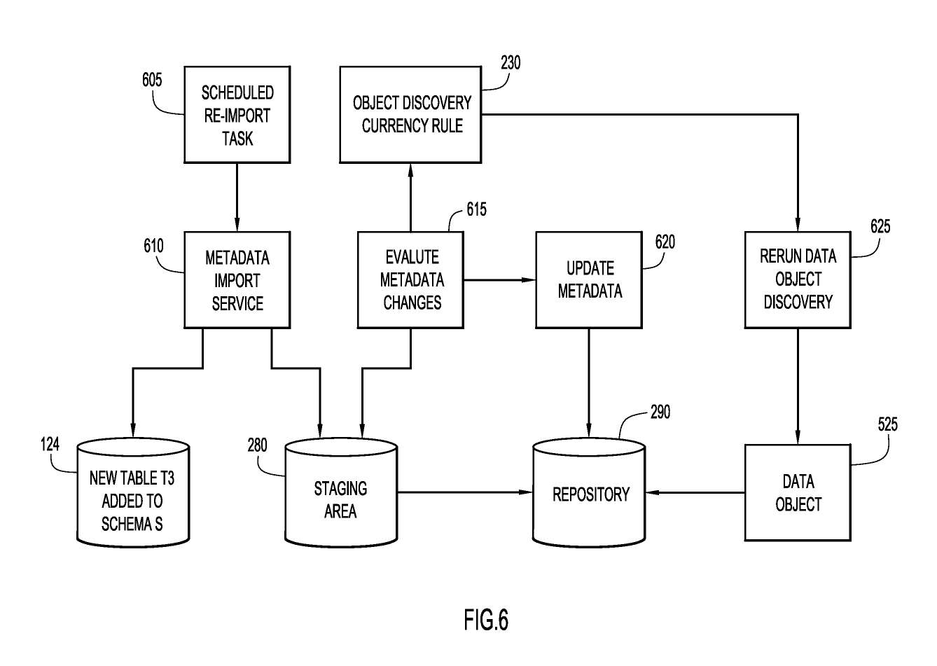

However, a present invention embodiment initiates a scheduled metadata refresh at step 605 (FIG. 6). Import service 240 (and corresponding connector 260) retrieves the metadata from a corresponding data source 124, and stores the metadata in staging repository 280 at step 610. The import service (or a corresponding connector 260) detects the addition of new table 505 (e.g., Table T3) within a corresponding data source 124 based on changes and/or additions in the incoming metadata at step 615. The import service may further determine, or utilize lineage service 242 to determine, that modified schema 510 (Schema S2) has table 520 (e.g., Table T2) that is also part of data object 525 (e.g., Customer).

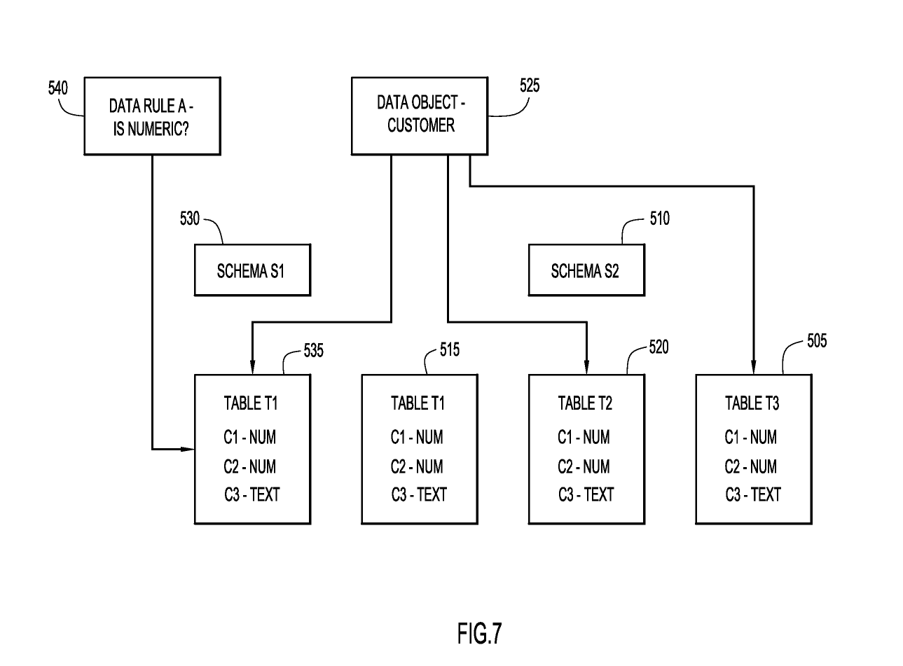

Data object 525 (e.g., Customer) is flagged or marked for re-evaluation, and all data rules that are applied to that data object are similarly flagged or marked. The respective data stewards or other users are notified of the identified data rules. Data currency rules 230 corresponding to the identified data rules for the data object are applied to perform a data object discovery re-evaluation to determine synchronization of the changed and/or added metadata with the identified data rules at step 625. The results of the refresh add new table 505 (e.g., Table T3) to data object 525 (e.g., Customer) in central metadata repository 290 at step 620, and may further provide updated data rules corresponding to the new table and changed/added metadata. This is further illustrated in FIG. 7.

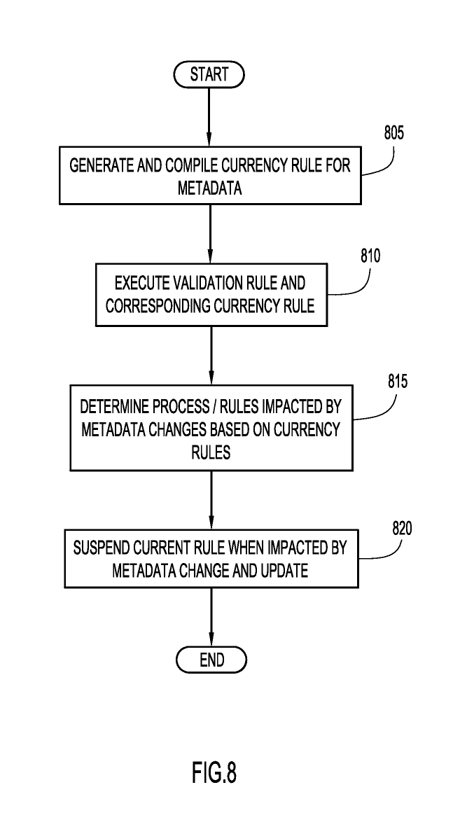

A manner of determining synchronization between data rules and corresponding metadata for those data rules at data rule execution according to an embodiment of the present invention is illustrated in FIGS. 3 and 8. Initially, data rules implementing the governance (business) policies are dynamically and automatically instrumented to check the currency of corresponding metadata at rule execution (or run time). This may be accomplished by extending the jobs (e.g., compiled data rules) generated to implement the data rules.

In particular, data validation or other rules 220 (FIG. 3) are compiled by rule compiler 222 to generate the jobs (and executable code) to implement those data rules. When the data rules are compiled, currency rules 230 are generated at step 805 (FIG. 8) to determine if corresponding metadata on data sources 124 for the data rules is current relative to the metadata in central metadata repository 290. The compiled data rule is extended by the rule compiler to execute the corresponding currency rule during the execution process for the data rule as described above. Currency rules 230 specify criteria in the form of conditions and/or variables (e.g., with values retrieved from data sources 124 and/or central metadata repository 290) to verify currency of metadata for a corresponding data rule 220 (e.g., verify that the metadata is synchronized with the corresponding data rule). The currency rules generally vary depending on the data, data rule, metadata, and a particular application. For example, when a data rule includes a numeric or certain type of data element, a currency rule may be generated to ensure the metadata reflects the numeric or certain type for that data element. Alternatively, a user may provide the currency rules for the extensions to (or to be executed with) the compiled data rules.

When data is imported or refreshed (or at a scheduled time for, or user initiation of, data verification), data rules 220 are utilized to verify the data. The data rules and corresponding currency rules are executed by rule engine 224 at step 810. The currency rules are executed by rule engine 224 during the execution process of the corresponding data rule to identify data rules as potentially obsolete (or lacking synchronization with corresponding metadata) in response to violation of the corresponding currency rules at step 815. In addition, directly (and/or indirectly) impacted processes and/or objects (e.g., validation or other data rule on a modified column or a column whose value is derived from the modified column, etc.) are further identified according to the type of process (e.g., standardization, classification, de-duplication, validation, etc,) and the type of metadata change detected (e.g., created, modified, deleted, etc.). In this case, other data rules for currency verification may be identified based on changed metadata causing a currency rule violation.

Import service 240 may provide notifications 300 of the identified data rules (and currency rule violations) to a data steward or other user 285, and the execution of the corresponding data rules by rule engine 224 may be suspended. For example, when a violation of currency rule occurs during the execution process of a corresponding data rule, the rule engine may suspend or abort execution of the corresponding data rule. However, the rule engine completes processing of a data rule in response to a successful result of each of the currency rules associated with the data rule (e.g., indicating synchronization between the data rule and corresponding metadata). The currency rule may be executed prior to, but as part of the execution process for, the data rule in order to prevent the data rule from executing in the event of a currency rule violation.

The identified data rules may be modified based on the metadata changes at step 820. The data rule modifications may be implemented automatically by rule module 120. For example, a currency rule violation may indicate a modified data type for a table column (e.g., a text to numeric modification, etc. In this case, rule module 120 may modify the data rule or select a new data rule with the updated data type indicated in the changed metadata (e.g., modify the text to be numeric within the data rule, etc.). Alternatively, the data steward or other user may modify the data rule or select a new data rule according to notification 300. The modified or new data rule may be compiled by rule compiler 222 for execution (e.g., with extensions for executing corresponding currency rules).

The automatically generated metadata currency rules described above may be stored as a currency rule set and periodically executed (e.g., independent of the data rule, and as a scheduled or user initiated task) to enable identification of impacted governance processes (e.g., profiling, data quality, lineage, etc.) and/or objects, and trigger any required remediation tasks and notifications (e.g., in substantially the same manners described above for FIGS. 3-4). In this case, the rule compiler may compile the automatically generated rules to be executed outside the execution process for the corresponding data rule. The automatically generated rules (or meta-rules) on the quality or currency of the metadata can be associated with policies (or meta-policies) to be governed similar to any other governance policies and rules defined on the actual data.

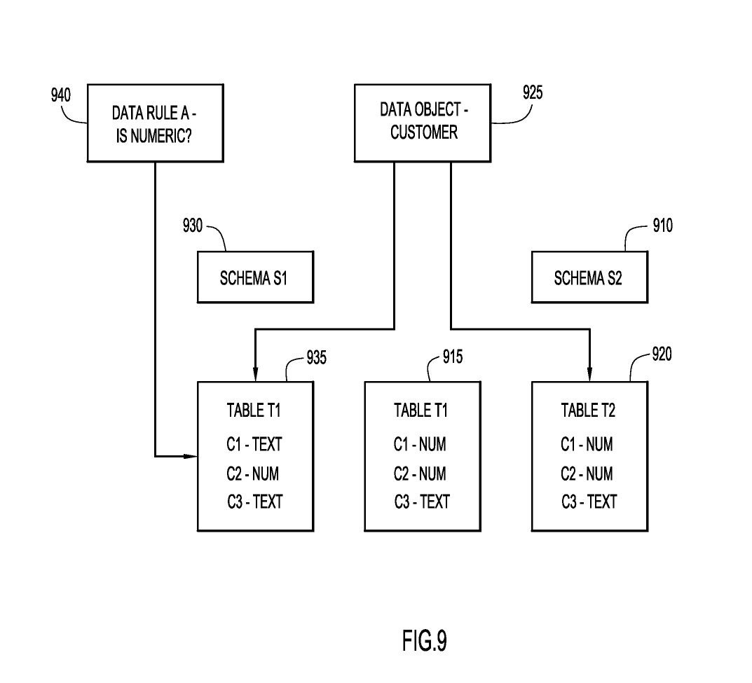

Operation of a present invention embodiment with respect to an example table modification is illustrated in FIGS. 9-11. By way of example, a schema 910 (e.g., Schema S2) includes tables 915 (e.g., Table T1) and 920 (e.g., Table T2) with table 920 (Table T2) being part of a definition of a data object 925 (e.g., Customer). The example further includes a schema 930 (Schema S1) including table 935 (Table T1 of Schema S1), and a data rule 940 (e.g., Data Rule A, verifying that a column contains only numeric characters (e.g., IsNumeric) and is bound to columns C1 and C2 in table 935). Table 935 (Table T1 of Schema S1) is part of the definition of data object 925 (e.g., Customer).

By way of example, table 935 (Table T1 of Schema S1) was changed to persist a social security number (SSN) using a standard “nn-nn-nnnn” alphanumeric or text format in column C1 rather than a numeric format. During the process of conversion, there were some data entries that resulted in “nn nnn nnnn” (e.g., lacking the dashes or hyphens of the updated SSN format). In this case, data rule 940 (e.g., Data Rule A) will fail on the changed column C1 since the format is alphanumeric, thereby requiring additional review. Until this review is completed, there is no assurance of the quality of the data in column C1.

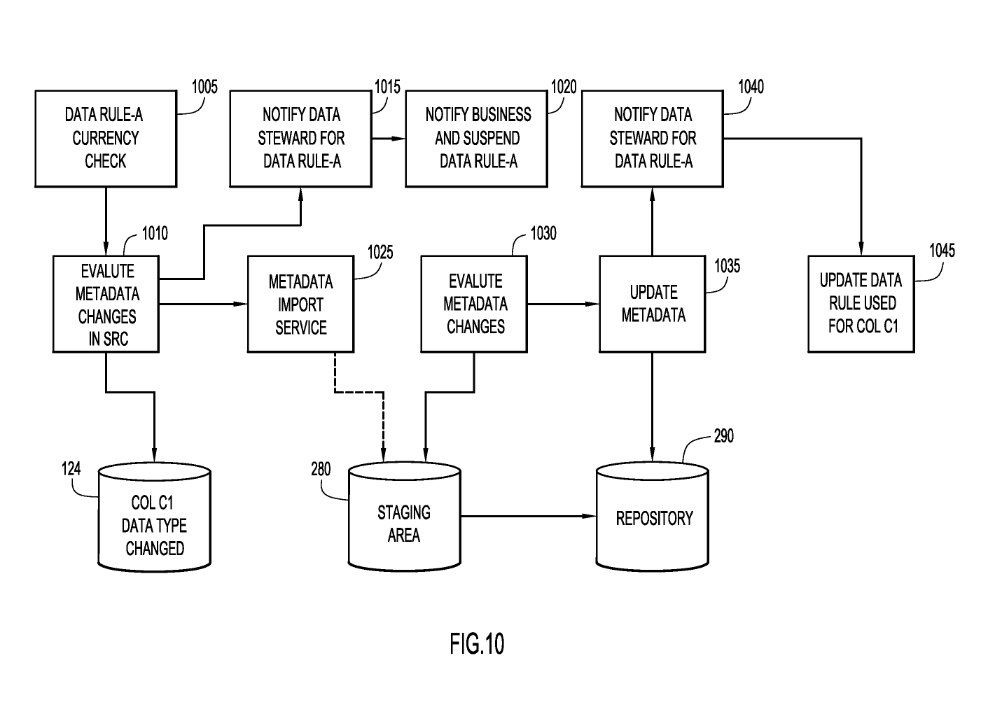

However, a present invention embodiment may check for currency of the metadata during data rule execution. In this case, rule engine 224 executes data rule 940 (e.g., Data Rule A) against corresponding incoming data at step 1005 (FIG. 10), and checks for currency of table 935 (e.g., Table T1 of Schema S1) with the incoming metadata during data rule execution at step 1010. Upon violation of the currency rule, rule engine 224 stops the rule execution and creates the appropriate event(s) and notifications at steps 1015 and 1020. A data steward or other user 285, having been automatically subscribed to events of currency rule violations for all tables assigned to that user, is notified of the change in the column data type (e.g., from numeric to text). The data steward or other user may check a metadata change report attached to a notification message to determine the impacted data rules.

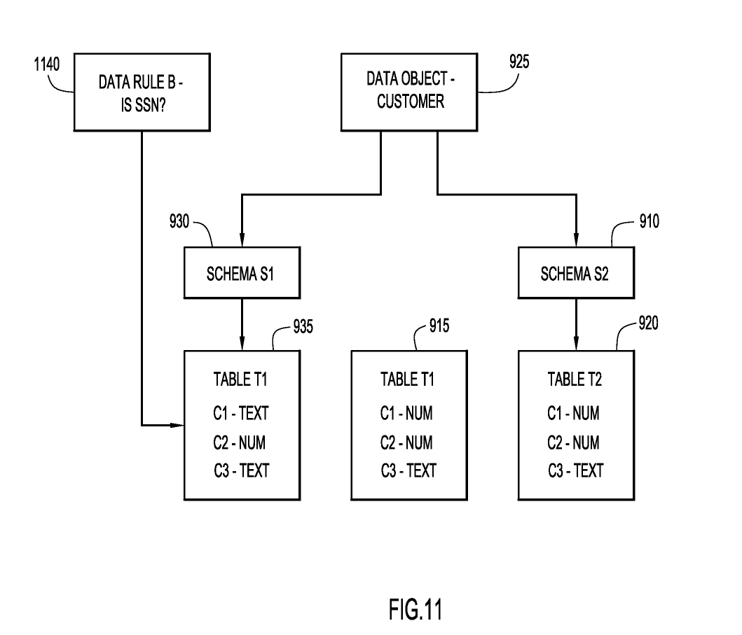

An appropriate data rule 1140 (FIG. 11) (e.g., Data Rule B) which checks that the information in column C1 adheres to the changed (e.g., SSN) format is enacted on column C1 at step 1045, instead of original data rule 940 (e.g., Data Rule). The new data rule may be determined by rule module 120, or by the data steward or other user. The new data rule is executed and detects any entries violating the SSN format (e.g., numeric entries and the entries lacking the hyphens (but no exceptions are generated for text entries in the proper SSN format)). The newly enacted data rule is further illustrated in FIG. 11.

In the case where the change is detected in response to a metadata refresh, import service 240 (and corresponding connector 260) retrieves the metadata from a corresponding data source 124, and stores the metadata in staging repository 280 at steps 1010, 1025. The import service (or a corresponding connector 260) detects the change to column C1 of table 935 (e.g., Table T1 of Schema S1) within a corresponding data source 124 based on the incoming metadata at step 1030. The import service may further determine, or utilize lineage service 242 to determine, the impacted objects, data rules, and/or processes.

Currency rules 230 are applied to determine synchronization of the changed metadata with the impacted data rules (associated with the impacted objects and/or processes) at step 1030. Data rule 940 (e.g., Data Rule A) is identified as lacking synchronization with the changed metadata, and a data steward or other user 285, having been automatically subscribed to events of currency rule violations is notified of the change in the column data type (e.g., from numeric to text) at step 1040. An appropriate data rule 1140 (FIG. 11) (e.g., Data Rule B) which checks that the information in column C1 adheres to the changed (e.g., SSN) format is enacted on column C1 at step 1040 (instead of original data rule 940 (e.g., Data Rule A)), and the metadata is updated accordingly in central data repository 290 at step 1035 to associate the new data rule with corresponding data. The new data rule may be determined by rule module 120, or by the data steward or other user. The new data rule is executed and detects any entries violating the SSN format (e.g., numeric entries and the entries lacking the hyphens (but no exceptions are generated for text entries in the proper SSN format)). The newly enacted data rule is further illustrated in FIG. 11.

Accordingly, an embodiment of the present invention monitors and enforces data rule currency to effectively avoid invalid rule violations, and enable valid rule violations to be addressed and remediated. Further, data rules impacted by metadata changes are detected and prevented from running, while minimal effort is needed to react to metadata changes due to automatic metadata change detection and immediate notification of changes (e.g., with links to impacted rules).

It will be appreciated that the embodiments described above and illustrated in the drawings represent only a few of the many ways of implementing embodiments for synchronizing data rules and corresponding metadata to implement data migration.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser/interface or other client modules, communications software, server software, rule module, data module, middleware module, etc.). These systems may include any types of monitors and input devices (e.g., keyboard, mouse, voice recognition, etc.) to enter and/or view information.

It is to be understood that the software (e.g., rule module, data module, middleware module, etc.) of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., rule module, data module, middleware module, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., data, metadata, data rules, currency rules, etc.). The database system may be implemented by any number of any conventional or other databases, data stores or storage structures (e.g., files, databases, data structures, data or other repositories, etc.) to store information (e.g., data, metadata, data rules, currency rules, etc.). The database system may be included within or coupled to the server and/or client systems. The database systems and/or storage structures may be remote from or local to the computer or other processing systems, and may store any desired data (e.g., data, metadata, data rules, currency rules, etc.).

The connectors or middleware may include any desired interface to access any type or quantity of data sources. Any quantity of the connectors may determine metadata changes, or simply pass retrieved data from the data sources to the import service to determine the changes. The checking of metadata for changes may distributed in any manner between the import service and connectors. The metadata changes may be detected in any desired fashion (e.g., timestamps, operations performed, data or data object comparisons, metadata comparisons, etc.). Further, any type of change to the metadata may be determined (e.g., changes to data objects or elements, changes to processes, changes to data or other metadata, etc.).

A server system of a present invention embodiment may include the verification, impact analysis, and/or staging repository, individually or in any combination. Alternatively, the incoming data may be placed directly in the central metadata repository without any of these processes. The central metadata repository may alternatively be implemented as a distributed repository with any quantity of remote or local data storage units.

The metadata may include any desired information (e.g., data source connections, databases, database schemas, tables, columns, keys, data files, data fields, jobs, data and currency rules, data transformations, etc.). The data may include any desired information.

The data verification (or application of data rules) may be performed at any desired instances (e.g., scheduled times, user initiated, at an application or process execution, etc.). The data rules may be of any quantity or type, and verify any desired properties of the data (e.g., validation, matching, standardization, masking, etc.). The data rules may include any quantity of any types of conditions, expressions, and/or variables to specify any criteria for verification. The data rules may be provided by a user, or automatically generated. The data rules may be assigned or bound to any desired data objects, data elements, and/or processes in any fashion.

The currency verification (or application of currency rules) may be performed at any desired instances (e.g., scheduled times, user initiated, at data rule run time, at an application or process execution, etc.). The currency and data rules may be at least partially executed in parallel for verification (e.g., at data rule run time, etc.). Any desired action may be perfumed automatically by the system or manually by a user in response to a currency rule violation (e.g., modify data rule, suspend or terminate data rule, replace data rule, etc.).

The currency rules may be of any quantity or type, and verify currency of any desired data or metadata (e.g., based on timestamps, changes, etc.). The currency rules may include any quantity of any types of conditions, expressions, and/or variables to specify any criteria for currency. The currency rules may be provided by a user, or automatically generated. The currency rules may be assigned or bound to any desired data or other rules, objects, data elements, and/or processes in any fashion.

The present invention embodiments may employ any number of any type of user interface (e.g., Graphical User Interface (GUI), command-line, prompt, etc.) for obtaining or providing information (e.g., impacted rules, data objects, notifications, exceptions and/or rule violations, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report and notifications may include any information arranged in any fashion, and may be configurable based on rules or other criteria to provide desired information to a user (e.g., impacted rules, data objects, exceptions, rule violations, etc.).

The present invention embodiments are not limited to the specific tasks or algorithms described above, but may be utilized for verifying currency of any data for any types of items (e.g., rules, conditions, expressions, data objects, data elements, processes, applications, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of monitoring metadata to control rule execution comprising:
detecting changes to metadata within one or more repositories;
identifying one or more data processing rules associated with the metadata having the detected changes;
determining an impact of the changed metadata on the identified one or more data processing rules; and
controlling execution of the one or more data processing rules based on the determined impact of the changed metadata.

2. The method of claim 1, wherein the detecting changes to metadata is performed at one of re-importation of metadata into a repository, periodic time intervals, and in response to a user command, and the determining an impact of the changed metadata is performed at one of execution of a data processing rule and a periodic time interval.

3. The method of claim 1, further comprising:
generating one or more metadata rules to determine an impact of the changes to the metadata for corresponding data processing rules, wherein the generated metadata rules verify currency of the metadata with the corresponding data processing rules and are performed at one of: execution of a corresponding data processing rule and a periodic time interval.

4. The method of claim 1, wherein the controlling execution of the one or more data processing rules further comprises:
notifying a user of data objects and the data processing rules impacted by the changes to the metadata.

5. The method of claim 1, wherein controlling execution of the one or more data processing rules further comprises:
executing a new data processing rule in accordance with the changes to the metadata.

6. The method of claim 1, wherein the changes to the metadata represent one or more from a group of: modification of a metadata object, addition of a new metadata object, and deletion of a metadata object.

7. The method of claim 1, wherein the one or more data processing rules include at least one data validation rule.

8. A system for monitoring metadata to control rule execution comprising:
at least one processor configured to:
detect changes to metadata within one or more repositories;
identify one or more data processing rules associated with the metadata having the detected changes;
determine an impact of the changed metadata on the identified one or more data processing rules; and
control execution of the one or more data processing rules based on the determined impact of the changed metadata.

9. The system of claim 6, wherein the detecting changes to metadata is performed at one of re-importation of metadata into a repository, periodic time intervals, and in response to a user command, and the determining an impact of the changed metadata is performed at one of execution of a data processing rule and a periodic time interval.

10. The system of claim 8, wherein the at least one processor is further configured to:
generate one or more metadata rules to determine an impact of the changes to the metadata for corresponding data processing rules, wherein the generated metadata rules verify currency of the metadata with the corresponding data processing rules and are performed at one of: execution of a corresponding data processing rule and a periodic time interval.

11. The system of claim 8, wherein the controlling execution of the one or more data processing rules further comprises:
notifying a user of data objects and the data processing rules impacted by the changes to the metadata.

12. The system of claim 8, wherein controlling execution of the one or more data processing rules further comprises:
executing a new data processing rule in accordance with the changes to the metadata.

13. The system of claim 8, wherein the one or more data processing rules include at least one data validation rule.

14. A computer program product for monitoring metadata to control rule execution comprising:
a computer readable storage medium having computer readable program code embodied therewith, the computer readable program code comprising computer readable program code configured to:
detect changes to metadata within one or more repositories;
identify one or more data processing rules associated with the metadata having the detected changes;
determine an impact of the changed metadata on the identified one or more data processing rules; and
control execution of the one or more data processing rules based on the determined impact of the changed metadata.

15. The computer program product of claim 14, wherein the detecting changes to metadata is performed at one of re-importation of metadata into a repository, periodic time intervals, and in response to a user command, and the determining an impact of the changed metadata is performed at one of execution of a data processing rule and a periodic time interval.

16. The computer program product of claim 14, wherein the computer readable program code further comprises computer readable program code configured to:
generate one or more metadata rules to determine an impact of the changes to the metadata for corresponding data processing rules, wherein the generated metadata rules verify currency of the metadata with the corresponding data processing rules and are performed at one of: execution of a corresponding data processing rule and a periodic time interval.

17. The computer program product of claim 14, wherein the controlling execution of the one or more data processing rules further comprises:
notifying a user of data objects and the data processing rules impacted by the changes to the metadata.

18. The computer program product of claim 14, wherein controlling execution of the one or more data processing rules further comprises:
executing a new data processing rule in accordance with the changes to the metadata.

19. The computer program product of claim 14, wherein the changes to the metadata represent one or more from a group of: modification of a metadata object, addition of a new metadata object, and deletion of a metadata object.

90. The computer program product of claim 14, wherein the one or more data processing rules include at least one data validation rule.
